(19) United States
(12) Patent Application Publication
(10) Pub. No.: US 2002/0195392 A1
(43) Pub. Date: Dec. 26, 2002

(54) Process for the preparation of monodisperse gel-type cation exchangers

(76) Inventors: Claudia Schmid, Leichlingen (DE); Wolfgang Podszun, Koln (DE); Rudiger Seidel, Leverkusen (DE); Reinhold Klipper, Koln (DE); Ralf-Jurgen Born, Langenfeld (DE); Olaf Halle, Koln (DE); Ulrich Schnegg, Leverkusen (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/135,798

(22) Filed: Apr. 30, 2002

(30) Foreign Application Priority Data
May 11, 2001 (DE) 10122896.1

(51) Int. Cl. C02F 1/42

(52) U.S. Cl. 210/681

(57) ABSTRACT

The invention relates to a process for preparing gel-type cation exchangers of high osmotic and mechanical stability and enhanced stability to oxidation by a seed/feed process, the seed used being a polymer containing 3.5-7% by weight of crosslinker.

The invention relates to a process for the preparation of gel-type cation exchangers highly stable to oxidation, the cation exchangers themselves and uses thereof.

Gel-type cation exchangers can be obtained by sulphonating crosslinked styrene polymers. Very recently, crosslinked styrene polymers produced by the seed/feed technique are increasingly being used.

Thus EP-00 98 130 B1 describes the preparation of gel-type styrene polymers by a seed/feed process in which the feed is added under polymerizing conditions to a seed which is crosslinked in advance using 0.1-3% by weight of divinylbenzene. EP-0 101 943 B1 describes a seed/feed process in which a plurality of feeds of differing composition are successively added under polymerizing conditions to the seed. U.S. Pat. No. 5,068,255 describes a seed/feed process in which a first monomer mix is polymerized up to a conversion rate of 10 to 80% by weight and then a second monomer mix without free-radical initiator is added as feed under polymerizing conditions. A disadvantage in the processes according to EP-00 98 130 Bi, EP-0 101 943 BI and U.S. Pat. No. 5,068,255 is the complicated metering in which the feed rate must be matched to the polymerization kinetics.

EP-A 0 826 704 and DE-A 19 852 667 disclose seed/feed processes using microencapsulated polymer particles as seed. The bead polymers produced by these processes are distinguished by a content of uncrosslinked soluble polymer which is increased compared with customary, directly synthesized bead polymers. This content of uncrosslinked soluble polymer is unwanted in the reaction to give ion exchangers, since the polymer contents which are dissolved out are accumulated in the reaction solutions used for the functionalisation. In addition, increased amounts of soluble polymer lead to unwanted leaching of the ion exchangers.

Leaching can also occur as a result of insufficient stability to oxidation of the cation exchangers. Stability to oxidation for the purposes of the present invention means that cation exchangers under oxidizing conditions, as usually occur in the use of ion exchangers, in combination with an anion exchanger release no constituents to the medium to be purified, preferably water. The release of oxidation products, generally polystyrene sulphonic acids, otherwise leads to an increase in conductivity in the eluate. The leaching of cation exchangers is a particular problem if the polystyrene sulphonic acids released have an elevated molecular weight in the range of approximately 10,000 to 100,000 g/mol.

A further problem of the cation exchangers prepared according to the above-mentioned prior art is their mechanical and osmotic stability which is not always adequate. Thus cation exchanger beads, during the dilution after sulphonation, can break as a result of the osmotic forces which occur. For all applications of cation exchangers, the exchangers which are present in bead form must retain their habit and must not be partially or completely broken down or disintegrate into fragments during use. Fragments and bead polymer splinters can pass into the solutions to be purified during purification and themselves contaminate these. In addition, the presence of damage bead polymers is itself unfavourable for the mode of functioning of the cation exchangers used in column processes. Splinters lead to an elevated pressure drop of the column system and thus decrease the throughput through the column of the liquid to be purified.

It is an object of the present invention to provide gel-type cation exchangers with high mechanical and osmotic stability and simultaneously improved stability to oxidation.

The present invention therefore relates to a process for the preparation of gel-type cation exchangers of improved stability to oxidation by a seed/feed process characterized in that

a) a bead-type crosslinked styrene polymer containing 3.5-7% by weight of crosslinker is provided as seed polymer in an aqueous suspension,

b) the seed polymer is allowed to swell in a monomer mix of vinyl monomer, crosslinker and free-radical initiator,

c) the monomer mix is polymerized in the seed polymer, and

d) the resultant copolymer is functionalized by sulphonation.

The seed polymer from process step a) contains 3.5-7% by weight, preferably 4.5-6% by weight, of crosslinker. Suitable crosslinkers are compounds which contain two or more, preferably two to four, double bonds polymerizable by free-radicals per molecule. Those which may be mentioned by way of example are: divinylbenzene, divinyltoluene, trivinylbenzene, divinylnaphthalene, trivinylnaphthalene, diethylene glycol divinyl ether, octa-1,7-diene, hexa-1,5-diene, ethylene glycol dimethacrylate, triethylene glycol dimethacrylate, trimethylol propanetrimethacrylate, allyl methacrylate or methylene-N,N′-bisacrylamide. Divinylbenzene is preferred as crosslinker. For most applications, commercial qualities of divinylbenzene, which, in addition to the isomers of divinylbenzene, also comprise ethylvinylbenzene, are adequate. The main constituent of the seed is styrene. In addition to styrene and crosslinker, other monomers can be present in the seed, for example in amounts of 1-15% by weight. Those which may be mentioned by way of example are acrylonitrile, vinylpyridine, methylacrylate, ethylacrylate, hydroxyethyl methacrylate or acrylic acid.

The particle size of the seed polymer is 5 to 750 μm, preferably 20 to 500 μm, particularly preferably 100 to 400 μm. The shape of the particle size distribution curve must correspond to that of the desired cation exchanger. To prepare a narrowly distributed or monodisperse ion exchanger in the context of the present invention, therefore, a narrowly distributed or monodisperse seed polymer is used. In a preferred embodiment of the present invention, a monodisperse seed polymer is used. Monodisperse in this context means that the ratio of the 90% value (Ø(90)) and the 10% value (Ø(10)) of the volumetric distribution function of particle sizes is less than 2, preferably less than 1.5, particularly preferably less than 1.25. The 90% value (Ø(90)) expresses the diameter which 90% of the particles fall below. Correspondingly, 10% of the particles fall below the diameter of the 10% value (Ø(10)). To determine the mean particle size and the particle size distribution, customary methods are suitable such as sieve analysis or image analysis.

In a further preferred embodiment of the present invention, the seed polymer is microencapsulated. Microencapsulated polymers suitable as seed can be obtained in accordance with EP-00 46 535 B1, the contents of which are hereby incorporated by the present application with respect to microencapsulation.

For the microencapsulation, the materials known for this application are suitable, in particular polyesters, natural and synthetic polyamides, polyurethanes, polyureas. As a natural polyamide, gelatin is particularly highly suitable. This is used in particular as coacervate and complex coacervate. Gelatin-containing complex coacervates for the purposes of the invention are taken to mean, especially, combinations of gelatin and synthetic polyelectrolytes. Suitable synthetic polyelectrolytes are copolymers having incorporated units of, for example, maleic acid, acrylic acid, methacrylic acid, acrylamide or methacrylamide. Gelatin-containing capsules can be cured using conventional curing agents, for example formaldehyde or glutardialdehyde. The encapsulation of monomer droplets with, for example, gelatin, gelatin-containing coacervates or gelatin-containing complex coacervates is described in detail in EP-00 46 535 B1. The methods of encapsulation using synthetic polymers are known. A highly suitable method is, for example, phase boundary condensation, in which a reactive component (for example an isocyanate or an acid chloride) dissolved in the monomer droplet is reacted with a second reactive component (for example an amine) dissolved in the aqueous phase. According to the present invention, the microencapsulation using gelatin-containing complex coacervate is preferred.

The seed polymer is preferably suspended in an aqueous phase, in which case the ratio of polymer and water can be between 2:1 and 1:20. Preferably, the ratio is 1:1.5 to 1:5. The use of an aid, for example a surfactant or a protecting colloid, is not necessary. Suspension can be performed, for example, using a standard agitator, preferably low to medium shearing forces being employed.

In process step b), a mixture (feed) of vinyl monomer, crosslinker and free-radical initiator is added to the suspended seed polymer.

Vinyl monomers which can be used are the monomers styrene, vinyltoluene, ethyl styrene, alpha-methyl styrene, chlorostyrene, acrylic acid, methacrylic acid, acrylic esters, methacrylic esters, acrylonitrile, methacrylonitrile, acrylamide, methacrylamide and mixtures of these monomers. Preference is given to mixtures of styrene and acrylonitrile. Particularly preferably, a mix of 86-98% by weight of styrene and 2-14% by weight of acrylonitrile is used. Very particular preference is given to a mix of 88-95% by weight of styrene and 5-12% by weight of acrylonitrile.

Crosslinkers which may be mentioned are divinylbenzene, divinyltoluene, trivinylbenzene, divinylnaphthalene, trivinylnaphthalene, diethylene glycol divinyl ether, octa-1,7-diene, hexa-1,5-diene, ethylene glycol dimethacrylate, triethylene glycol dimethacrylate, trimethylol propanetrimethacrylate, allyl methacrylate or methylene-N,N′-bisacrylamide. Divinylbenzene is preferred. For most applications, commercial qualities of divinylbenzene which, in addition to the isomers of divinylbenzene, also contain ethylvinylbenzene, are adequate. The crosslinker content in the monomer mix is 5-20% by weight, preferably 7 to 15% by weight.

Suitable free-radical initiators in the feed for the inventive process are, for example, peroxy compounds such as dibenzoyl peroxide, dilauroyl peroxide, bis(p-chlorobenzoyl peroxide), dicyclohexyl peroxydicarbonate, tert-butyl 2-ethyl-peroxyhexanoate, 2,5-bis(2-ethylhexanoylperoxy)-2,5-dimethylhexane or tert-amylperoxy-2-ethylhexane, tert-butyl peroxybenzoate, and in addition azo compounds such as 2,2′-azobis(isobutyronitrile) and 2,2′-azobis(2-methylisobutyronitrile). Preferably, mixtures of free-radical initiators, in particular mixtures of free-radical initiators having different decomposition kinetics, for example mixtures of tert-butyl 2-ethylperoxyhexanoate and tert-butyl peroxybenzoate are used. The free-radical initiators are generally employed in amounts of 0.05 to 2.5% by weight, preferably 0.2 to 1.5% by weight, based on the mixtures of monomer and crosslinker.

The ratio of seed polymer to added mixture (seed/feed ratio) is generally 1:0.25 to 1:5, preferably 1:0.5 to 1:2.5, particularly preferably 1:0.6 to 1:1.6. In view of the high crosslinker content of the seed, it is surprising that the added monomer mix, under the inventive conditions, soaks completely into the seed polymer. At a given particle size of the seed polymer, the particle size of the resultant copolymer or the ion exchanger may be set via the seed/feed ratio.

The monomer mix soaks into the seed polymer at a temperature at which none of the added free-radical initiators is active. Generally, the soaking is performed at 0-60° C. and lasts for approximately 0.5 to 5 h.

The swollen seed polymer is polymerized to form the copolymer in accordance with process step c) in the presence of one or more protecting colloids and, if appropriate, a buffer system. Suitable protecting colloids in the context of the present invention are natural and synthetic water-soluble polymers, for example gelatin, starch, polyvinyl alcohol, polyvinylpyrrolidone, polyacrylic acid, polymethacrylic acid or copolymers of (meth)acrylic acid and (meth)acrylic esters. Those which are very highly suitable are also cellulose derivatives, in particular cellulose esters or cellulose ethers, such as carboxymethyl cellulose or hydroxyethyl cellulose. Cellulose derivatives are preferred as protecting colloids in the context of the present invention. The amount of protecting colloids used is generally 0.05 to 1% by weight, based on the water phase, preferably 0.1 to 0.5% by weight. The protecting colloid can be added in the form of an aqueous solution, and it is generally not added until after the monomer mix has soaked into the seed.

The polymerization according to process step c) can be carried out in the presence of a buffer system. Preference is given to buffer systems which set the pH of the water phase at the start of polymerization to a value between 14 and 6, preferably between 13 and 9. Under these conditions protecting colloids containing carboxylic acid groups are entirely or partially salts. In this manner the effect of the protecting colloids is favourably influenced. Particularly highly suitable buffer systems in the context of the present invention contain phosphate or borate salts.

In a particular embodiment of the present invention, the aqueous phase contains a dissolved inhibitor. Suitable inhibitors are not only inorganic but also organic substances. Examples of inorganic inhibitors are nitrogen compounds, such as hydroxylamine, hydrazine, sodium nitrite and potassium nitrite. Examples of organic inhibitors are phenolic compounds such as hydroquinone, hydroquinone monomethyl ether, resorcinol, catechol, tert-butyl catechol or condensation products of phenols with aldehydes. Other organic inhibitors are nitrogen compounds, for example diethyl hydroxylamine and isopropylhydroxylamine. Resorcinol is preferred as inhibitor in the context of the present invention. The concentration of the inhibitor is 5-1000 ppm, preferably 10-500 ppm, particularly preferably 20-250 ppm, based on the aqueous phase.

The ratio of organic phase to water phase in the polymerization of the swollen seed is 1:0.8 to 1:10, preferably 1:1 to 1:5.

The temperature during the polymerization of the swollen seed polymer depends on the decomposition temperature of the initiator/initiators used. It is generally between 50 and 150° C., preferably between 55 and 140° C. Polymerization lasts for 2 to 20 hours. It has proven useful to employ a temperature programme in which the polymerization starts at low temperature, for example 60° C., and as the polymerization conversion rate advances, the reaction temperature is increased, for example to 130° C. It has been found that polymerization in a broad temperature range, for example when at least two free-radical initiators having different decomposition kinetics are used, leads to cation exchangers having outstanding mechanical and osmotic stability.

After polymerization the copolymer can be isolated by conventional methods, for example by filtration or decanting, and if appropriate, after one or more washes, dried and if desired screened.

The copolymers are converted to the cation exchanger in accordance with the process step d) by sulphonation. Suitable sulphonating agents in the context of the present invention are sulfuric acid, sulfur-trioxide and chlorosulphonic acid. Preference is given to sulfuric acid at a concentration of 90-100% by weight, particularly preferably 96-99% by weight. The temperature during sulphonation is generally 60-180° C., preferably 90-130° C., particularly preferably 95° C-110° C. It has been found that the inventive copolymers can be sulphonated without adding swelling agents (for example chlorobenzene or dichloroethane) and give homogeneous sulphonation products.

During sulphonation the reaction mix is stirred. Various agitator types can be used for this, such as blade agitators, anchor agitators, mesh agitators or turbine agitators. It has been found that a radially transporting twin-turbine agitator is particularly highly suitable.

In a particularly preferred embodiment of the present invention, sulphonation is performed in accordance with the semi-batch process. In this method the copolymer is added to the heated sulfuric acid. It is particularly advantageous in this case to carry out addition a little at a time.

After sulphonation the reaction mix of sulphonation product and residual acid is cooled to room temperature and diluted initially with sulfuric acids of decreasing concentration and then with water.

The overall process can be carried out continuously, batchwise or semi-batchwise. In a preferred manner, the process is carried out in a process-controlled plant.

The present invention further relates to the gel-type cation exchangers of improved stability to oxidation obtainable by a seed/feed process by

a) providing as seed polymer an aqueous suspension of a bead-type crosslinked styrene polymer containing 3.5-7% by weight of crosslinker,

b) swelling the seed polymer in a monomer mix of vinyl monomer, crosslinker and free-radical initiator,

c) polymerizing the monomer mix in the seed polymer and

d) functionalizing the resultant copolymer by sulphonation.

For all applications it is expedient to convert the cation exchangers obtainable according to the invention from the acid form into the sodium form. This conversion is performed using sodium hydroxide solution of a concentration of 1-60% by weight, preferably 3-10% by weight.

The cation exchangers obtained by the inventive process are distinguished by a particularly high stability and purity. Even after relatively long usage and regeneration many times, they display no defects on the ion-exchange beads and no leaching of the exchanger.

It has been found that the inventive cation exchangers, even at low contents of divinylbenzene as crosslinker, for example 6.5 to 7.6% by weight of DVB in the copolymer, have an advantageously high total capacity of 2.1 to 2.4 equivalents/l.

For cation exchangers there is a multiplicity of different applications. Thus, they are used, for example, in drinking water treatment, in the production of ultrapure water (necessary in production of microchips for the computer industry), for chromatographic separation of glucose and fructose, and as catalysts of various chemical reactions (for example in bisphenol-A production from phenol and acetone). For most of these uses it is desirable that the cation exchangers compete the tasks assigned to them without releasing to their surroundings impurities which can originate from their production or are formed during use by polymer breakdown. The presence of impurities in the effluent water from the cation exchanger is made noticeable by the conductivity and/or the total organic carbon (TOC) content of the water being increased.

The inventive cation exchangers are also outstandingly suitable for desalinating water. Even after relatively long service lives of the desalination plants, increased conductivity is not observed. Even if the structure-property correlation of the inventive cation exchangers is not known in all details, it is probable that the favourable leaching properties are due to the particular network structure.

The present invention therefore relates to the use of the inventive cation exchangers

for removing cations, pigment particles or organic components from aqueous or organic solutions and condensates, for example process condensates or turbine condensates,

for softening, in neutral exchange, aqueous or organic solutions and condensates, for example process condensates or turbine condensates,

for purifying and working up water streams of the chemical industry, the electronics industry and from power stations,

for demineralizing aqueous solutions and/or condensates, characterized in that these are used in combination with gel-type and/or macroporous anion exchangers,

for decolourizing and demineralizing wheys, gelatin cooking broths, fruit juices, fruit musts and aqueous sugar solutions,

as the finely ground powder form alone, or if appropriate in a mixture with strongly basic anion exchangers, for filtering or demineralizing water streams, for example condensates or in hydrometallurgy.

The present invention therefore also relates to

processes for demineralizing aqueous solutions and/or condensates, for example process condensates or turbine condensates, characterized in that, according to the invention, monodisperse cation exchangers are used in combination with heterodisperse or monodisperse, gel-type and/or macroporous anion exchangers,

combinations of inventively prepared monodisperse cation exchangers with heterodisperse or monodisperse, gel-type and/or macroporous anion exchangers for demineralizing aqueous solutions and/or condensates, for example process condensates or turbine condensates,

processes for purifying and treating water streams of the chemical industry, the electronics industry and from power stations, characterized in that monodisperse cation exchangers are used according to the invention,

processes for removing cations, pigment particles or organic components from aqueous or organic solutions and condensates, for example process condensates or turbine condensates, characterized in that the monodisperse cation exchangers are used according to the invention,

processes for softening in neutral exchange aqueous or organic solutions and condensates, for example process condensates or turbine condensates, characterized in that monodisperse cation exchangers are used according to the invention,

processes for decolourizing and desalinating wheys, gelatin cooking broths, fruit juices, fruit musts and aqueous sugar solutions in the sugar industry, starch industry or pharmaceutical industry or dairies, characterized in that inventively prepared monodisperse cation exchangers are used.

### EXAMPLES

Analytical Methods:

Determination of Conductivity in Cation Exchanger Eluates

1 l of deionized water is circulated firstly via 1l of the cation exchanger under test, in the H form, and then via 5 ml of anion exchanger type Mono Plus H 500® (Bayer AG, Leverkusen) with a circulation range of 7 l/h at 25° C. The conductivity of the circulated water is determined in μS/cm after 70 h.

Determination of the Molecular Weight of Polystyrenesulphonic Acids in Cation Exchanger Eluates

The molecular weight of the polystyrenesulphonic acids in the water which has been pumped for 70 h to circulate through cation and anion exchangers is determined using gel-permeation chromatography, using polystyrene sulphonic acids of known molecular weight as standard substances.

### Example 1

### Comparative Example

a) Preparation of a copolymer

A copolymer was prepared in accordance with Example 2a-b) of EP-A 1 000 659.

b) Preparation of a Cation Exchanger

1400 ml of 98.4% strength by weight sulfuric acid are introduced into a 2 l four-necked flask and heated to 100° C. A total of 350 g of dry copolymer from 1a) is introduced in 10 portions in 4 hours with stirring. The mixture is then stirred for a further 6 hours at 120° C. After cooling, the suspension is transferred to a glass column. Sulfuric acids of decreasing concentration, starting at 90% by weight, and finally pure water, are filtered through the column from the top. 1630 ml of cation exchanger in the H form are obtained.

c) Conversion of a Cation Exchanger

To convert the cation exchanger from the H form to the sodium form, 1610 ml of sulphonated product from 1b) and 540 ml of deionized water are placed in a 6 l glass reactor at room temperature. 2489 ml of 5% strength by weight aqueous sodium hydroxide solution are added to the suspension in 120 minutes. The mixture is then stirred for a further 15 minutes. Thereafter the product is washed with deionized water. 1490 ml of cation exchanger in the Na form are obtained.

| | |
|---|---|
| Total capacity (Na form) in mol/l | 2.01 |
| Conductivity in the eluate after 70 h, in μS/cm | 3.296 |
| Molecular weight of the polystyrenesulphonic acids | 23000 |
| in the eluate, in g/mol | |

### Example 2

### According to the Invention

a) Preparation of a Copolymer

An aqueous solution of 3.6 g of boric acid and 1.0 g of sodium hydroxide in 1100 g of deionized water are placed in a 4 l glass reactor. To this are added 600.2 g of monodisperse microencapsulated seed polymer containing 95% by weight of styrene and 5.0% by weight of divinylbenzene. The seed polymer was prepared according to EP-00 46535 B1. The capsule wall of the seed polymer consists of a formaldehydecured complex coacervate of gelatin and an acrylamide/acrylic acid copolymer. The mean particle size of the seed polymer is 365 μm and the Ø(90)/Ø(10) value is 1.05. The mix is stirred at a stirrer speed of 220 rpm. In the course of 30 min, a mix of 476.2 g of styrene, 48.0 g of acrylonitrile, 76.0 g of divinylbenzene (80.6% strength by weight), 2.2 g of tert-butyl 2-ethylperoxyhexanoate and 1.5 of tert-butyl peroxybenzoate is added as feed. The mix is stirred for 2 hours at 50° C., the gas space being flushed with nitrogen. Thereafter a solution of 2.4 g of methyl hydroxyethyl cellulose in 120 g of deionized water is added and stirred for 1 hour at 50° C. The batch is heated to 63° C. and kept for 10 hours at this temperature, then stirred for 3 hours at 130° C. After cooling, the batch is washed with deionized water over a 40 μm screen and then dried for 18 hours in a drying cabinet at 80° C. 1164 g of a bead-type copolymer having a particle size of 460 μm and a Ø(90)/Ø(10) value of 1.07 are obtained.

b) Preparation of a Cation Exchanger

1400 ml of 98.2% strength by weight sulfuric acid are placed in a 2 l four-necked flask and heated to 100° C. In the course of 4 hours, a total of 350 g of dry copolymer from 2a) are introduced in 10 portions with stirring. The mixture is then stirred for a further 6 hours at 120° C. After cooling the suspension is transferred to a glass column. Sulfuric acids of decreasing concentration starting with 90% by weight, and finally pure water, are filtered through the column from the top. 1460 ml of cation exchanger in the H form are obtained.

c) Conversion of a Cation Exchanger

To convert the cation exchanger from the H form to the sodium form, 1440 ml of sulphonated product from 2b) and 450 ml of deionized water are placed in a 6 l glass reactor at room temperature. 2230 ml of 5% strength by weight aqueous sodium hydroxide solution are added in the course of 120 minutes. The suspension is then stirred for a further 15 minutes. The product is then washed with deionized water. 1340 ml of cation exchanger in the Na form are obtained.

| | |
|---|---|
| Total capacity (Na form) in mol/l | 2.23 |
| Conductivity in the eluate after 70 h, in μS/cm | 0.360 |
| Molecular weight of the polystyrenesulphonic acids | 1100 |
| in the eluate, in g/mol | |

### Example 3

### According to the Invention

a) Preparation of a Copolymer

An aqueous solution of 3.6 g of boric acid and 1.0 g of sodium hydroxide in 1100 g of deionized water is placed in a 4 l glass reactor. To this are added 648.9 g of monodisperse microencapsulated seed polymer containing 95% by weight of styrene and 5.0% by weight of divinyl benzene. The seed polymer was prepared in accordance with EP-00 46535 B1. The capsule wall of the seed polymer consists of a formaldehyde-cured complex coacervate of gelatin and an acrylamide/acrylic acid copolymer. The mean particle size of the seed polymer is 375 μm and the Ø(90)/Ø(10) value is 1.06. The mix is stirred at a stirrer speed of 220 rpm. In the course of 30 min, a mixture of 430.5 g of styrene, 48.0 g of acrylonitrile, 73.0 g of divinylbenzene (80.6% strength by weight), 2.0 g of tert-butyl 2-ethylperoxyhexanoate and 2.0 g of tert-butyl peroxybenzoate is added as feed. The mix is stirred for 2 hours at 50° C., the gas space being flushed with nitrogen. Thereafter a solution of 2.4 g of methyl hydroxyethyl cellulose in 120 g of deionized water is added and the mix is stirred for 1 hour at 50° C. The batch is heated to 61° C. and kept for 10 hours at this temperature, and then stirred for 3 hours at 130° C. The batch, after cooling, is washed with deionized water over a 40 μm screen and then dried in a drying cabinet at 80° C. for 18 hours. 1140 g of a bead-type copolymer having a particle size of 460 μm and a Ø(90)/Ø(10) value of 1.07 are obtained.

b) Preparation of a Cation Exchanger

1400 ml of 98.1% strength by weight sulfuric acid are placed in a 2 l four-necked flask and heated to 100° C. In the course of 4 hours, the total of 350 g of dry copolymer from 3a) is introduced in 10 portions with stirring. The mix is then stirred for a further 6 hours at 105° C. After cooling the suspension is transferred to a glass column. Sulphuric acids of decreasing concentration, starting at 90% by weight, and finally pure water, are filtered through the column from the top. 1480 ml of cation exchanger in the H form are obtained.

c) Conversion of a Cation Exchanger

To convert the cation exchanger from the H form to the sodium form, 1460 ml of sulphonated product from 3b) and 450 ml of high-purity water are placed into a 6 l glass reactor at room temperature. 2383 ml of 5% strength by weight aqueous sodium hydroxide solution are added to the suspension in the course of 120 minutes. The mixture is then stirred for a further 15 minutes. Thereafter, the product is washed with deionized water. 1380 ml of cation exchanger in the Na form are obtained.

| | |
|---|---|
| Total capacity (Na form) in mol/l | 2.21 |
| Conductivity in the eluate after 70 h, in μS/cm | 0.136 |
| Molecular weight of the polystyrenesulphonic acids | <1000 |
| in the eluate, in g/mol | |

### Example 4

### According to the Invention

a) Preparation of a Copolymer

An aqueous solution of 3.6 g of boric acid and 1.0 g of sodium hydroxide in 1100 g of deionized water is placed in a 4 l glass reactor. To this are added 631.8 g of monodisperse microencapsulated seed polymer containing 95% by weight of styrene and 5.0% by weight of divinylbenzene. The seed polymer was prepared in accordance with EP-00 46535 B1. The capsule wall of the seed polymer consisted of a formaldehyde-cured complex coacervate of gelatin and an acrylamide/acrylic acid copolymer. The mean particle size of the seed polymer is 365 μm and the Ø(90)/Ø(10) value 1.05. The mixture is stirred at an agitator speed of 220 rpm. In the course of 30 min, a mix of 463 g of styrene, 48.0 g of acrylonitrile, 57.6 g of divinylbenzene (80.6% strength by weight), 2.1 g of tert-butyl 2-ethylperoxyhexanoate and 1.4 g of tert-butyl peroxybenzoate is added as feed. The mix is stirred at 50° C. for 2 hours, the gas space being flushed with nitrogen. Thereafter a solution of 2.4 g of methyl hydroxyethyl cellulose in 120 g of deionized water is added and the mixture is stirred for 1 hour at 50° C. The batch is heated to 61° C. and kept at this temperature for 10 hours, then stirred for 3 hours at 130° C. After cooling, the batch is washed with deionized water over a 40 μm screen and then dried in a drying cabinet at 80° C. for 18 hours. 1121 g of a bead-type copolymer having a particle size of 450 μm and a Ø(90)/Ø(10) value of 1.05 are obtained.

b) Preparation of a Cation Exchanger

1400 ml of 98.4% strength by weight sulphuric acid are placed in a 2 l four-necked flask and heated to 100° C. In the course of 4 hours, a total of 350 g of dry copolymer from 4a) are introduced in 10 portions with stirring. The mixture is then stirred for a further 6 hours at 120° C. After cooling, the suspension is transferred to a glass column. Sulphuric acids of decreasing concentration, starting with 90% by weight, and finally pure water, are filtered through the column from the top. 1480 ml of cation exchanger in the H form are obtained.

c) Conversion of a Cation Exchanger

To convert the cation exchanger from the H form to the sodium form, 1460 ml of sulphonated product from 4b) and 450 ml of deionized water are placed in a 6 l glass reactor at room temperature. In the course of 120 minutes, 2400 g of 5% strength by weight aqueous sodium hydroxide solution are added to the suspension. The mixture is then stirred for a further 15 minutes. Thereafter the product is washed with deionized water. 1330 ml of cation exchanger in the Na form are obtained.

| | |
|---|---|
| Total capacity (Na form) in mol/l | 2.18 |
| Conductivity in the eluate after 70 h, in μS/cm | 0.540 |
| Molecular weight of the polystyrenesulphonic acids | 2000 |
| in the eluate, in g/mol | |

### Example 5

### According to the Invention

a) Preparation of a copolymer

An aqueous solution of 3.6 g of boric acid and 1.0 g of sodium hydroxide in 1100 g of deionized water is placed in a 4 l glass reactor. To this are added 600.2 g of monodisperse microencapsulated seed polymer containing 95% by weight of styrene and 5.0% by weight of divinylbenzene. The seed polymer was prepared in accordance with EP-00 46535 B 1. The capsule wall of the seed polymer consists of a formaldehyde-cured complex coacervate of gelatin and an acrylamide/acrylic acid copolymer. The mean particle size of the seed polymer is 365 μm and the Ø(90)/Ø(10) value 1.05. The mix is stirred at an agitator speed of 220 rpm. In the course of 30 min, a mix of 504.6 g of styrene, 36.0 g of acrylonitrile, 59.6 g of divinylbenzene (80.6% strength by weight), 2.2 g of tert-butyl 2-ethylperoxyhexanoate and 1.5 g of tert-butyl peroxybenzoate as feed is added. The mix is stirred for 2 hours at 50° C., the gas space being flushed with nitrogen. Thereafter a solution of 2.4 g of methyl hydroxyethyl cellulose in 120 g of deionized water is added and stirred for 1 hour at 50° C. The batch is heated to 61° C. and kept for 10 hours at this temperature, then stirred for 3 hours at 130° C. After cooling, the batch is washed with deionized water over a 40 μm screen and then dried in a drying cabinet at 80° C. for 18 hours. 1176 g of a bead-type copolymer having a particle size of 460 μm and a Ø(90)/Ø(10) value of 1.06 are obtained.

b) Preparation of a Cation Exchanger

1400 ml of 98.5% strength by weight sulphuric acid are placed in a 2 l four-necked flask and heated to 100° C. In the course of 4 hours, a total of 350 g of dry copolymer from 5a) are introduced in 10 portions with stirring. The mixture is then stirred for a further 6 hours at 105° C. After cooling, the suspension is transferred to a glass column. Sulphuric acids of decreasing concentration, starting with 90% by weight, and finally pure water, are filtered through the column from the top. 1500 ml of cation exchanger in the H form are obtained.

c) Converting a Cation Exchanger

To convert the cation exchanger from the H form to the sodium form, 1480 ml of sulphonated product from 5b) and 450 ml of deionized water are placed at room temperature in a 6 l glass reactor. In the course of 120 minutes, 2364 ml of 5% strength by weight aqueous sodium hydroxide solution are added to the suspension. The mixture is then stirred for a further 15 minutes. Thereafter, the product is washed with deionized water. 1380 ml of cation exchanger in the Na form are obtained.

| | |
|---|---|
| Total capacity (Na form) in mol/l | 2.19 |
| Conductivity in the eluate after 70 h, in μS/cm | 0.301 |
| Molecular weight of the polystyrenesulphonic acids | 1500 |
| in the eluate, in g/mol | |

### Example 6

### According to the Invention

a) Preparation of a Copolymer

An aqueous solution of 3.6 g of boric acid and 1.0 g of sodium hydroxide in 1100 g of deionized water is placed in a 4 l glass reactor. To this are added 600.2 g of monodisperse microencapsulated seed polymer containing 95% by weight of styrene and 5.0% by weight of divinylbenzene. The seed polymer was prepared according to EP-00 46535 B 1. The capsule wall of the seed polymer consists of a formaldehydecured complex coacervate of gelatin and an acrylamide/acrylic acid copolymer. The mean particle size of the seed polymer is 365 μm and the Ø(90)/Ø(10) value 1.05. The mix is stirred at an agitator speed of 220 rpm. In the course of 30 min, a mix of 476.2 g of styrene, 48.0 g of acrylonitrile, 76.0 g of divinylbenzene (80.6% strength by weight), 2.2 g of tert-butyl 2-ethylperoxyhexanoate and 1.5 g of tert-butyl peroxybenzoate is added as feed. The mixture is stirred for 3 h at 30° C., the gas space being flushed with nitrogen. Thereafter a solution of 2.4 g of methyl hydroxyethyl cellulose in 120 g of deionized water is added and stirred for 1 hour at 30° C. The batch is heated to 61° C. and kept for 8 hours at this temperature, then stirred for 3 hours at 130° C. After cooling, the batch is washed with deionized water over a 40 μm screen and then dried in a drying cabinet at 80° C. for 18 hours. 1133 g of a bead-type copolymer having a particle size of 460 μm and a Ø(90)/Ø(10) value of 1.07 are obtained.

b) Preparation of a Cation Exchanger

1400 ml of 98.2% strength by weight sulphuric acid are placed in a 2 l four-necked flask and heated to 100° C. In the course of 4 hours, a total of 350 g of dry copolymer from 6a) are introduced in 10 portions with stirring. The mixture is then stirred for a further 6 hours at 105° C. After cooling, the suspension is transferred to a glass column. Sulphuric acids of decreasing concentration, starting with 90% by weight, and finally pure water, are filtered through the column from the top. 1440 ml of cation exchanger in the H form are obtained.

c) Conversion of a Cation Exchanger

To convert the cation exchanger from the H form to the sodium form, 1420 ml of sulphonated product from 6b) and 450 ml of deionized water are placed in a 6 l glass reactor at room temperature. In the course of 120 minutes, 2337 ml of 5% strength by weight aqueous sodium hydroxide solution are added to the suspension. The mixture is then stirred for a further 15 minutes. Thereafter the product is washed with deionized water. 1340 ml of cation exchanger in the Na form are obtained.

| | |
|---|---|
| Total capacity (Na form) in mol/l | 2.24 |
| Conductivity in the eluate after 70 h, in μS/cm | 0.333 |
| Molecular weight of the polystyrenesulphonic acids | 1000 |
| in the eluate, in g/mol | |

### Example 7

### According to the Invention

a) Preparation of a Copolymer

An aqueous solution of 3.6 g of boric acid and 1.0 g of sodium hydroxide in 1100 g of deionized water is placed in a 4 l glass reactor. To this are added 600.2 g of monodisperse microencapsulated seed polymer containing 95% by weight of styrene and 5.0% by weight of divinylbenzene. The seed polymer was prepared according to EP-00 46535 B1. The capsule wall of the seed polymer consists of a formaldehyde-cured complex coacervate of gelatin and an acrylamide/acrylic acid copolymer. The mean particle size of the seed polymer is 365 μm and the Ø(90)/Ø(10) value 1.05. The mix is stirred at an agitator speed of 220 rpm. In the course of 30 min, a mix of 485.2 g of styrene, 48.0 g of acrylonitrile, 67.0 g of divinylbenzene (80.6% strength by weight), 2.2 g of tert-butyl 2-ethylperoxyhexanoate and 1.5 g of tert-butyl peroxybenzoate is added as feed. The mix is stirred for 2 hours at 50° C., the gas space being flushed with nitrogen. Thereafter a solution of 2.4 g of methyl hydroxyethyl cellulose in 120 g of deionized water is added and stirred for 1 hour at 50° C. The batch is heated to 63° C. and kept at this temperature for 10 hours, then stirred for 3 hours at 130° C. After cooling, the batch is washed with deionized water over a 40 μm screen and then dried in a drying cabinet at 80° C. for 18 hours. 1169 g of a bead-type copolymer having a particle size of 460 μm and a Ø(90)/Ø(10) value of 1.08 are obtained.

b) Preparation of a Cation Exchanger

1400 ml of 98.1% strength by weight sulphuric acid are placed in a 2 l four-necked flask and heated to 100° C. In the course of 4 hours, a total of 350 g of copolymer from 7a) are introduced in 10 portions with stirring. The mixture is then stirred for a further 6 hours at 120° C. After cooling, the suspension is transferred to a glass column. Sulphuric acids of decreasing concentration, starting with 90% by weight, and finally pure water, are filtered through the column from the top. 1480 ml of cation exchanger in the H form are obtained.

c) Conversion of a Cation Exchanger

To convert the cation exchanger from the H form to the sodium form, 1460 ml of sulphonated product from 7b) and 450 ml of deionized water are placed in a 6 l glass reactor at room temperature. In the course of 120 minutes, 2361 ml of 5% strength by weight aqueous sodium hydroxide solution are added to the suspension. The mixture is then stirred for a further 15 minutes. Thereafter the product is washed with deionized water. 1350 ml of cation exchanger in the Na form are obtained.

| | |
|---|---|
| Total capacity (Na form) in mol/l | 2.17 |
| Conductivity in the eluate after 70 h, in μS/cm | 0.457 |
| Molecular weight of the polystyrenesulphonic acids | 2500 |
| in the eluate, in g/mol | |

### Example 8

### According to the Invention

a) Preparation of a Copolymer

An aqueous solution of 3.6 g of boric acid, 1.0 g of sodium hydroxide and 0.10 g of resorcinol in 1100 g of deionized water are placed in a 4 l glass reactor. To this are added 648.9 g of monodisperse microencapsulated seed polymer containing 95% by weight of styrene and 5.0% by weight of divinylbenzene. The seed polymer was prepared in accordance with EP-00 46535 B1. The capsule wall of the seed polymer consists of a formaldehyde-cured complex coacervate of gelatin and an acrylamide/acrylic acid copolymer. The mean particle size of the seed polymer is 375 μm and the Ø(90)/Ø(10) value 1.06. The mix is stirred at an agitator speed of 220 rpm. In the course of 30 min, a mix of 430.5 g of styrene, 48.0 g of acrylonitrile, 73.0 g of divinylbenzene (80.6% strength by weight), 2.0 g of tert-butyl 2-ethylperoxyhexanoate and 1.4 g of tert-butyl peroxybenzoate are added as feed. The mix is stirred for 2 hours at 50° C., the gas space being flushed with nitrogen. Thereafter a solution of 2.4 g of methyl hydroxyethyl cellulose in 120 g of deionized water is added and stirred for 1 hour at 50° C. The batch is heated to 61° C. and kept for 10 hours at this temperature, then stirred for 3 hours at 130° C. After cooling, the batch is thoroughly washed with deionized water over a 40 μm screen and then dried in a drying cabinet at 80° C. for 18 hours. 1144 g of a bead-type copolymer having a particle size of 460 μm and a Ø(90)/Ø(10) value of 1.07 are obtained.

b) Preparation of a Cation Exchanger

1400 ml of 98.5% strength by weight sulphuric acid are placed in a 2 l four-necked flask and heated to 100° C. In the course of 4 hours, a total of 350 g of dry copolymer from 8a) are introduced in 10 portions with stirring. The mixture is then stirred for a further 6 hours at 105° C. After cooling, the suspension is transferred to a glass column. Sulphuric acids of decreasing concentration, starting with 90% by weight, and finally pure water, are filtered through the column from the top. 1430 ml of cation exchanger in the H form are obtained.

c) Conversion of a Cation Exchanger

To convert the cation exchanger from the H form to the sodium form, 1410 ml of sulphonated product from 8b) and 450 ml of deionized water are placed in a 4 l glass reactor at room temperature. In the course of 120 minutes, 1752 ml of 5% strength by weight aqueous sodium hydroxide solution are added to the suspension. The mixture is then stirred for a further 15 minutes. Thereafter the product is washed with deionized water. 1325 ml of cation exchanger in the Na form are obtained.

| | |
|---|---|
| Total capacity (Na form) in mol/l | 2.22 |
| Conductivity in the eluate after 70 h, in μS/cm | 0.092 |
| Molecular weight of the polystyrenesulphonic acids | <1000 |
| in the eluate, in g/mol | |

Surprisingly, the cation exchangers prepared according to the invention exhibit, after 70 hours, a markedly lower conductivity in the eluate than cation exchangers prepared in accordance with EP-A 10 00 659.

We claim:

1. Process for preparing gel-type cation exchangers of improved stability to oxidation by a seed/feed process, which comprises
a) providing a bead-type crosslinked styrene polymer containing 3.5-7% by weight of crosslinker in an aqueous suspension as seed polymer,
b) adding a monomer mix of vinylmonomer, crosslinker and free-radical initiator to the aqueous suspension, whereupon the monomer mix soaks into the seed polymer, and the seed polymer becomes swollen,
c) polymerizing, within the seed polymer, the monomer mix which has soaked into the seed polymer and,
d) functionalizing the resultant copolymer by sulphonation.

2. Process according to claim 1, wherein the bead-type crosslinked styrene polymer in process step a) has a particle size distribution in which the quotient of the 90% value and the 10% value of the volume distribution function is less than 2.

3. Process according to claim 1, wherein the seed polymer is microencapsulated.

4. Process according to claim 1, wherein the content of crosslinker in the monomer mix of process step b) is 5 to 20% by weight.

5. Process according to claim 1, wherein the vinyl monomer of process step b) is a mix of
88-98% by weight of styrene and
2-14% weight of acrylic monomer.

6. Process according to claim 5, wherein the acrylic monomer is acrylonitrile.

7. Process according to claim 1, wherein the free-radical initiator is an aliphatic perester.

8. Process according to claim 1, wherein the polymerization in process step c) is conducted within the temperature range of 50-150° C.

9. Process according to claim 1, wherein the monomer mix in process step b) contains a mix of at least two different free-radical initiators.

10. Gel-type cation exchanger obtainable by a seed/feed process by
a) providing an aqueous suspension of a bead-type crosslinked styrene polymer, as seed polymer, containing 3.5-7% by weight of crosslinker,
b) swelling the seed polymer in a monomer mix of vinyl monomer, crosslinker and free-radical initiator,
c) polymerizing the monomer mix in the seed polymer and
d) functionalizing the resultant copolymer by sulphonation.

11. A process for removing cations, pigment particles or organic components from aqueous or organic solutions and condensates, for softening, in neutral exchange, aqueous or organic solutions and condensates, for purifying and treating water streams of the chemical industry, the electronics industry and from power stations, for demineralizing aqueous solutions and/or condensates, characterized in that these are used in combination with gel-type and/or macroporous anion exchangers, for decolourizing and demineralizing wheys, gelatin cooking broths, fruit juices, fruit musts and aqueous sugar solutions, ground to fine powder form alone or optionally in a mixture with strongly basic anion exchangers for the filtration or demineralization of water streams, which comprises conducting said process by contact with the cation exchanger of claim 10.
